(19) United States
(12) Patent Application Publication
(10) Pub. No.: US 2014/0092879 A1
(43) Pub. Date: Apr. 3, 2014

(54) DOWNLINK TRANSMISSION POINT SELECTION IN A WIRELESS HETEROGENEOUS NETWORK

(71) Applicant: ZTE Wistron Telecom AB, Stockholm (SE)

(72) Inventors: Jan Johansson, Norrfjarden (SE); Patrick Svedman, Stockholm (SE); Yonghong Gao, Stockholm (SE); Aijun Cao, Stockholm (SE); Thorsten Schier, Stockholm (SE); Bojidar Hadjiski, Stockholm (SE)

(73) Assignee: ZTE WISTRON TELECOM AB, Stockholm (SE)

(21) Appl. No.: 14/044,640

(22) Filed: Oct. 2, 2013

Related U.S. Application Data
(60) Provisional application No. 61/708,981, filed on Oct. 2, 2012.

(51) Int. Cl. H04L 5/00

(52) U.S. Cl. CPC H04L 5/0053
USPC 370/336

(57) ABSTRACT

A heterogeneous wireless communication network comprises a macrocell base station that includes a first transmission point, at least one microcell base station that includes a second transmission point and a controller configured to enable transmission of wireless data from the macrocell base station and the at least one microcell base station to a user equipment (UE). The controller is configured to determine a set of transmission point combinations for providing downlink data, determine, using a statistics of ACKs and NACKs received for previous downlink transmissions from the transmission point combinations, a sequence of downlink transmissions to the UE from the transmission point combinations in the set.

### CROSS REFERENCE TO RELATED APPLICATIONS

This patent application claims the benefit of U.S. Provisional Patent Application No. 61/708,981, filed Oct. 2, 2012. The entire content of the before-mentioned patent application is incorporated by reference as part of the disclosure of this application.

### BACKGROUND

This document relates to cellular telecommunication systems, including heterogeneous networks where one or more low-power nodes are deployed at least partially within the coverage area of a macro base station.

Cellular communication systems are being deployed all over the world to provide voice services, mobile broadband data services and multimedia services. There is a growing need for cellular bandwidth due to various factors, including the continuous increase in the number of mobile phones such as smartphones that are coming on line and deployment of new mobile applications that consume large amounts of data, e.g., mobile applications in connection with video and graphics. As mobile system operators add new mobile devices to the network, deploy new mobile applications and increase the geographic areas covered by broadband mobile services, there is an ongoing need to cover the operator's coverage area with high bandwidth connectivity.

### SUMMARY

The cellular bandwidth in a given coverage area can be increased by a number of techniques, including improving the spectrum efficiency for the point-to-point link and splitting communication cells into smaller cells. In cell splitting, when the split cells become small and close to one another, the adjacent cell interferences can become significant and may lead to the cell splitting gain saturation as the number of split cells in a given area increases to above a certain number. Furthermore, nowadays it is increasingly difficult to acquire new sites to install base stations and the costs for adding new base stations are increasing. These and other factors render it difficult to use cell-splitting to fulfill the increasing bandwidth demands.

This document describes technologies, among other things, for selecting downlink transmission point combinations in a wireless heterogeneous network (HetNet).

In one aspect, methods, systems and apparatus are disclosed for providing downlink data to a user equipment (UE) using a plurality of geographically separated transmission points in a wireless communication network. A set of transmission point combinations for providing downlink data is determined. For each transmission point combination in the set, an error tracking loop is operated to track downlink transmission errors for the transmission point combination. Data is provided to the UE by time multiplexing downlink transmissions from the transmission point combinations such that a number of times a given transmission point combination is used over a time period is a function of the tracked downlink transmission errors for the given transmission point combination.

In another aspect, a wireless communication network includes a macrocell base station that includes a first transmission point. The wireless communication network also includes at least one microcell base station that includes a second transmission point. The wireless communication further includes a controller configured to enable transmission of wireless data from the macrocell base station and the at least one microcell base station to a user equipment (UE) by determining a set of transmission point combinations for providing downlink data, determining, using a statistics of ACKs and NACKs received for previous downlink transmissions from the transmission point combinations, a sequence of downlink transmissions to the UE from the transmission point combinations in the set.

These and other aspects, and their implementations and variations are set forth in the drawings, the description and the claims.

### BRIEF DESCRIPTION OF THE DRAWINGS

FIG. 1 depicts a wireless HetNet deployment scenario.

FIG. 2 depicts another wireless HetNet deployment scenario.

FIG. 3 depicts another wireless HetNet deployment scenario.

FIG. 4 depicts a wireless HetNet deployment scenario in which multiple low power nodes (LPNs) operate within a macrocell base station's coverage area.

FIG. 5 depicts a transmission sequence useful in a HetNet deployment.

FIG. 6 depicts another transmission sequence useful in a HetNet deployment.

FIG. 7 is a flow chart representation of a process of wireless communications.

FIG. 8 is a block diagram representation of a wireless network apparatus.

Like reference symbols in the various drawings indicate like elements.

### DETAILED DESCRIPTION

The techniques disclosed in this document, in one aspect, can be implemented in ways that improve the operation of a heterogeneous network (HetNet) by facilitating selection of downlink transmission point combination for providing data to user equipment (UE). In one advantageous aspect, the selection of downlink transmission point is based on a quality metric that is generated by using an error rate of downlink data transmissions received at the UE. The use of an error measurement in the downlink direction rather than in the uplink direction provides an accurate control on the transmission point selection acts upon the same downlink channel that the error rate is measured on.

In another advantageous aspect, the selection of downlink transmission point combinations uses data link layer acknowledgements (ACKs) or non-acknowledgements (NACKs). In several wireless systems, ACK/NACKs transmitted by UEs for data connectivity and therefore the downlink transmission point selection does not require any additional complexity of implementation in a UE and does not require any additional signal transmissions on the air interface, thereby minimizing transmission overheads.

The techniques described in this document are applicable to a wireless network serving one or more user equipment (UE) devices, such as a mobile phone or a wireless communication device including a tablet or laptop computer. The wireless network can be a heterogeneous network (HetNet) deployment having multiple tiers of communication nodes/base stations such as macro base stations (or macrocell base stations) and micro base stations (or microcell base stations). A macro base station in such a HetNet has sufficiently high transmission power to cover a large macro cell area while a micro base station is a low power node (LPN) that covers a smaller area within the larger macro cell area or is at least partially within the coverage area of a macro base station.

In a HetNet, when a UE is operational in a network that includes multiple downlink transmissions points such as macro base stations and one or more micro base stations, the network can communicate downlink data to the UE by using one or more of the downlink transmission points. For example, when the UE is close to the macro base station and far away from the micro base station, all downlink data transmissions may be performed from the macro base station. However, as the UE begins to move closer to the micro base station, the downlink data to the UE may be provided using the macro base station on some occasions while using a nearby micro base station on other occasions. The relative frequency with which the different possible downlink transmission point combinations are used may be adjusted based on packet errors for each transmission point combination, as reported by the receiving UE. For example, as a UE moves from a location very close to a macro base station to another location being very close to a micro base station, the number of times the micro base station is used to provide downlink data burst transmissions to the UE may be gradually increased, e.g., from 0% when the UE is closest to the macro base station to 100% when the UE is closest to the micro base station.

The selection of which downlink transmission point combination to use, and to what extent to use it, may depend on uplink and/or downlink transmission characteristics of the network. In some implementations, an uplink transmission criterion (e.g., the signal power level received from the UE) may be used to decide whether or not to use a given transmission point combination at all, while a downlink transmission criteria (e.g., the downlink error rate) may be used to determine a frequency of use of the given transmission point combination. Other possibilities are further discussed below.

One possible way in which the available spectrum can be used more efficiently to provide higher bandwidth data to user equipment is by selecting the best possible combination of one or more downlink transmission points for transmitting data to UEs. As further discussed below, criteria for deciding which combination of transmission points is the “best” option depends on how the performance is measured. One possible way to measure performance, for example, is the system capacity, or the number of UEs that can be simultaneously served, and the peak or average downlink data rate offered to the UEs. Another possible criterion, for example, may be in terms of which transmission points result in the longest battery life for UEs. A third possible criterion may be the application layer data latency experienced by UEs receiving downlink transmissions. Yet another operational criterion is to consider the combination of downlink transmission point that operates at the highest modulation configuration (i.e., maximum number of bits per constellation symbol). Other criteria are also possible.

In some embodiments discussed below, the network may be able to completely avoid deciding which transmission point combination is “the best” by using all transmission point combinations to the extent of their previous history of successful delivery of packets, e.g., using a combination that has in the recent past delivered downstream data with fewer errors to a UE more often that another combination which has delivered downstream data to the UE with greater errors.

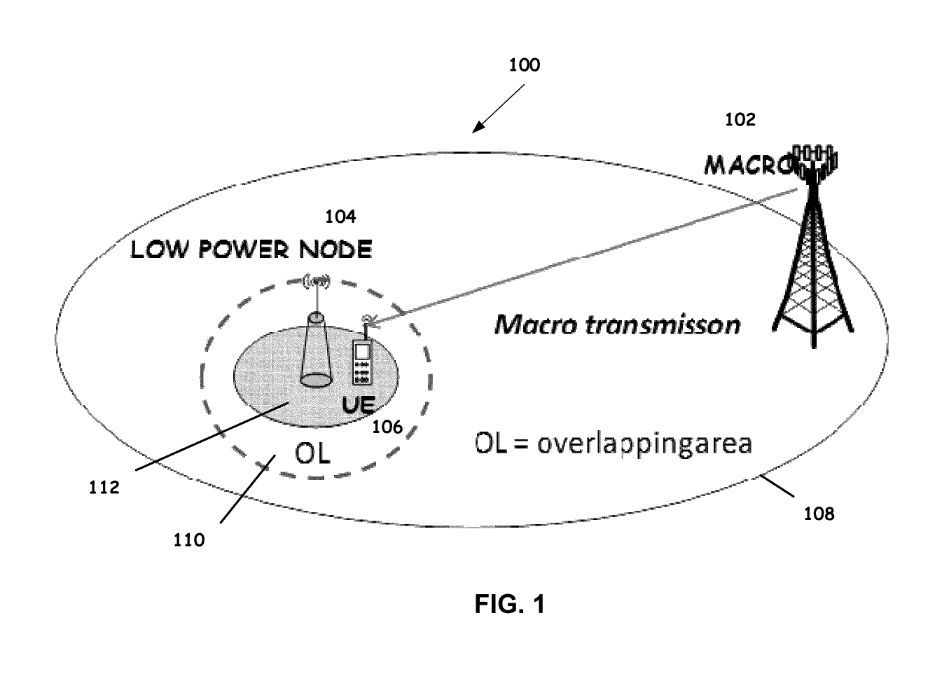

With reference to FIGS. 1, 2 and 3, some HetNet deployment scenarios related to the presently disclosed techniques are now discussed.

FIG. 1 depicts an example of a wireless communications network 100 that includes at least one macro base station 102 having a coverage area 108. The coverage area, macrocell 108, is shown as having a simplified oval geometric shape only for simplicity of explanation. In actual deployments, the coverage area of a macro base station 102 may be in other geometries which may include disjoint shapes. As illustrated in FIG. 1, the UE 106 is located in the macrocell 108. The UE 106 is also located in the coverage area 112 of a low power node (LPN) 104, which may be, sometimes, called a micro base station or a femtocell base station.

At the overlap region between the LPN coverage area (or microcell) 112 and the macrocell 108 is an overlapping area (OL) 110. The OL 110 may be in various geometrical shapes, e.g., including a contiguous area or two or more separated areas. The OL 110 may generally include one or more areas in which a UE 106 can establish two-way communication with either one of the LPN 104 and the macro base station 102 and can operate to receive/transmit data from either one of the LPN 104 and the macro base station 102. In some deployment scenarios, the microcell 112 may extend from less than a meter to about 30 to 40 meters away from the LPN 104, and the OL 110 may be approximately 10 to 30 meters wide and the macrocell 108 may extend from typically a kilometer or less to several 10s of kilometers (e.g., 10 km). The shapes and sizes of the OL 110 can vary based on a wireless network service provider's infrastructure.

In various deployments, such as depicted in FIGS. 1, 2 and 3, both the macro base station 102 and the LPN 104 may be equipped with multiple transmission points. A transmission point represents an individual physical antenna or a group of antennas. Therefore, in a wireless heterogeneous network that includes one macro base station 102 and at least one LPN 104, the network may be able to use different combination of antennas, i.e., different transmission point combinations, to provide downlink transmissions to UEs 106.

FIG. 1 further shows a specific downlink transmission situation in which UE 106 is located within the coverage area 112 of the LPN 104 but is receiving downlink data from the macro base station 102 via a high power downlink transmission channel from the macro base station rather than a possible low power downlink transmission channel from the LPN 104.

In FIG. 1, when UE 106 is sufficiently close to the LPN 104, such as the case specifically shown, using the macro base station 102 to transmit downlink data to the UE 106 located in the coverage area 112 of the LPN 104 may provide inferior operational point than using LPN 104 to provide the downlink traffic to the UE 106. This is because using the macro base station 102 may use a unnecessarily large amount of power when a lower power downlink transmission from the LPN 104 is available to the UE 106. The use of high power downlink transmission from the macro base station 102 may cause adverse interference to other transmissions in the network or the transmission from the macro base station 102 may be configured to use a lower modulation scheme (bits per constellation point) to reduce such adverse interference at a cost of reducing bits per Hertz efficiency of the wireless network. Furthermore, on the uplink side, the UE 106 may use high power transmissions to reach the macro base station 102, thereby causing significant battery usage and also potentially interfering with other transmissions in the network.

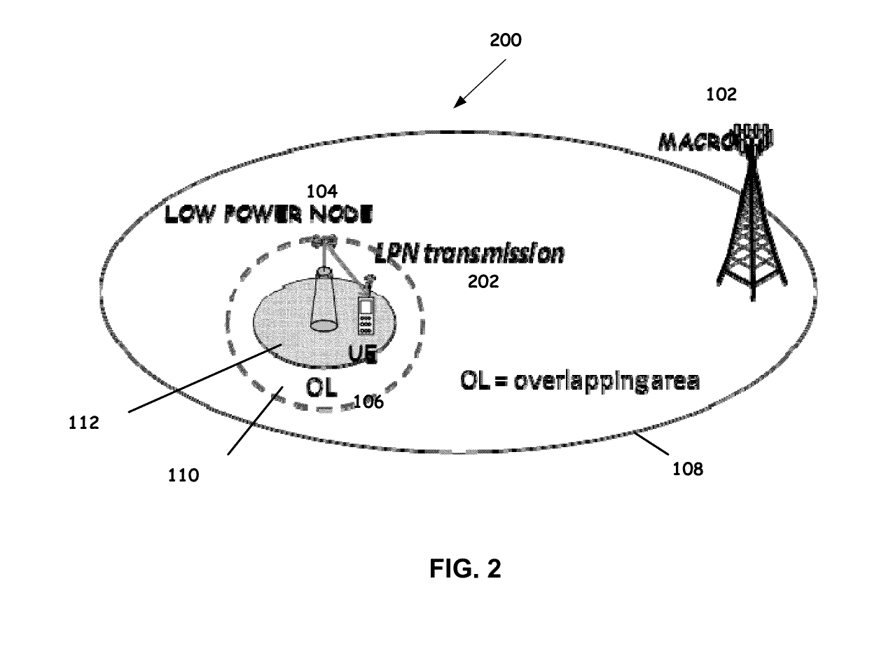

FIG. 2 depicts a different downlink transmission situation 200 in the same wireless HetNet in FIG. 1 in which downlink transmission to a UE 106 in the coverage area 112 of the LPN 104 or the OL 110 is from the LPN 104 in the microcell coverage area of the LPN 104 instead of the high power downlink transmission from the macro base station 102 in FIG. 1. This downlink transmission from the LPN 104 may be controlled to eliminate any significant or noticeable interference in the macrocell 108. Thus the UEs or cell phones operating in the macrocell 108 may be able to reuse the same frequency band used by the downlink transmission from the LPN 104 to the UE 106 in the LPN area 112. This resource reuse can improve the wireless capacity in the downlink transmission configuration 200 in FIG. 2.

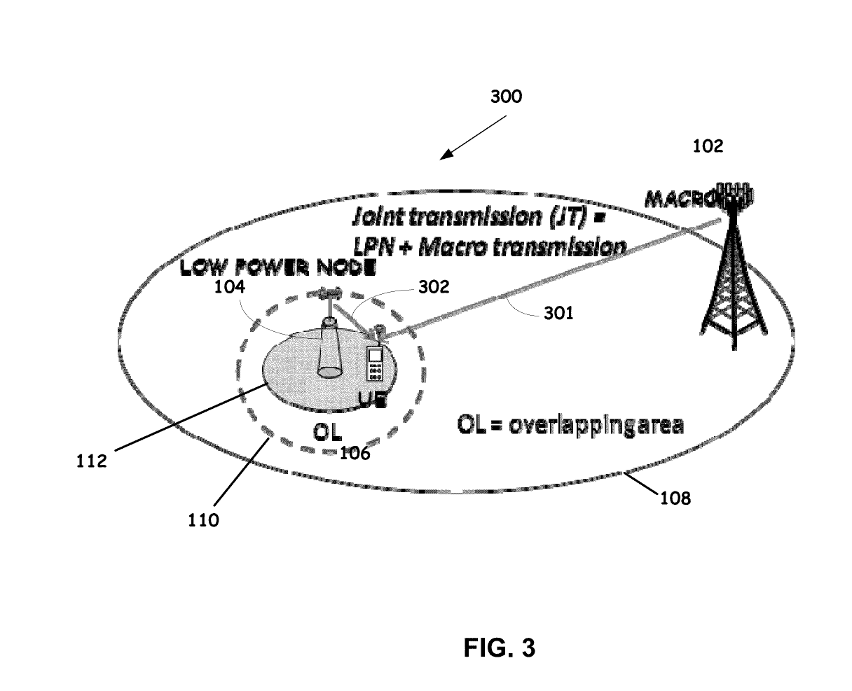

FIG. 3 illustrates another example 300 of a downlink transmission situation in the wireless HetNet in FIG. 1 in which downlink transmission to UE 106 within the coverage area 112 of the LPN 104 or the OL 110 is achieved by simultaneously transmitting from both the Macro base station 102 via a downlink transmission channel 301 and the LPN(s) 104 via a downlink transmission channel 302. This use of multiple transmission points may be beneficial in certain situations, e.g., when the cell phone (UE 106) is located in the overlapping (OL) 110 area. However, because of the use in the overlapping area 110, when the UE 106 is in the LPN area 112, it may not be possible to reuse the resource in the Macro area 108.

In various deployments, such as depicted in FIGS. 1, 2 and 3, both the macro base station 102 and the LPN 104 may be equipped with multiple transmission points to provide downlink transmissions to UEs 106. Various deployments of heterogeneous networks lack a framework by which operational efficiency can be achieved by systematically using the available downlink transmission antennas that are geographically located at different places. The techniques described here allow for systematically using the available downlink transmission antennas that are geographically located at different places in the HetNet for downlink transmission to UE 106 based on the location of the UE 106 with respect to the macro base station 102 and a nearby LPN 104.

The location of a UE 106 can be determined using one or more of several possible techniques. For example, in some implementations, the uplink power of transmissions from the UE 106 received at nodes 102, 104 may be used (e.g., compared to an expected power value) to estimate the distance between the UE 106 and nodes 102, 104. Based on the distance measured using uplink power estimate, the UE location may be estimated based on triangulation. In some configurations, the antennas (transmission points) at a node 104 or 102 that receives the highest power from the UE 106 may then be used to provide downlink data transmissions to the UE 106.

When communication channels from the UE 106 to the nodes 102, 104 are symmetric (i.e., downlink and uplink transmission channels are identical), the above use of the received uplink transmission power by a node can produce acceptable network performance. However, the determination of the downlink transmission points based on uplink power estimates may not be reliable under certain operational conditions. For example, channels in the uplink and downlink directions from a radio environment perspective do not have to be the same and may often be different. For example, in some embodiments, at a base station 102 or 104, the points at which uplink transmissions from the UE 106 are received and the transmission points from which downlink transmissions are made to the UE 106 need not be the same or co-located antennas. As another example, in some deployments, different carrier frequencies might be used for the uplink and downlink transmissions, and the path loss may not be the same in uplink and downlink transmissions. In these and other situations, it would be beneficial to use downlink information to determine the UE location for the downlink transmission point selection.

Examples provided below enable HetNet deployments to use a downlink operational parameter for determining downlink transmission point selection.

The techniques as further discussed below, in one aspect, use downlink channel performance to select downlink transmission points. In another aspect, existing quality of service mechanisms (QOS), such as ACK/NACK transmissions, can be used in deciding transmission point combinations to use for downlink transmissions, thereby resulting in no additional traffic overhead in implementation of the transmission point selection techniques described below.

In digital communication, the data rate that can be sustained at or above a given transmission error rate (e.g., packet error rate or bit error rate) depends on transmission characteristics such as the signal to noise ratio between the transmitter (e.g., base station and the receiver (e.g., UE 106). In various implementations, the transmitter is provided with a feedback from the receiver about the error rate of the received signal. The transmitter optionally can use the feedback to adjust transmission parameters such as the modulation constellation used, the error coding used, the pre-coding matrix, or other transmission parameters.

As one specific example, in Long Term Evolution (LTE), the transmitter (e.g., the base station) selects a suitable modulation and coding scheme (MCS) based on the signal to noise ratio. The MCS used for downlink transmissions is conveyed to the receiver using an MCS index in a way such that a numerically higher value of the MCS index indicates a higher constellation (i.e., higher number of bits encoded per constellation point). Upon the reception of a block of data in the UE 106, the UE 106 sends back an acknowledgment (ACK) if the data was successfully decoded. If the data could not be decoded correctly the cell phone sends back a not-acknowledgement (NACK). The base station can use this information to adaptively change the MCS to get a target quality of service (QOS), e.g. less than 10% of the data blocks may be decoded incorrectly.

In some implementations, downlink transmissions may be performed using different antenna combinations or transmission point combinations. A controller in the wireless network may use the ACK/NACK information to form multiple outer loop link adaptation controls that are run in parallel such that the ACK/NACK information for a given transmission point combination is used to track errors for that transmission point combination. As previously discussed, at least three possible transmission combinations exist when a UE 106 can be served by a macro base station 102 or LPN 104. One combination may be “macro base station only;” another combination may be “LPN 104 only” and a third combination may be “both macro 102 and LPN 104.” In addition, for each of these three combinations, additional possibilities exists about which particular antennas or transmission points are used. It will be appreciated that when the UE 106 can be served by multiple LPNs 104, then the number of possible combinations increases further.

In some implementations, a separate MCS for each transmission combination may be used, thereby forming a set of multiple MCS that may be tracked and updated by the network. In some implementations, the set contains the MCS for the Macro (MCSM), the MCS for the LPNs (MCSLPN(i)) (i is an integer index number) and the MCS for the joint transmissions (MCSJT(n)) (n is an integer index number). The set {MCSM, MCSJT(n), MCSLPN(i)} is updated (e.g., using low pass filtering or a windowed moving average of the different MSCs) depending on from where the current transmission is performed. For instance, if a single transmission from a LPN is done, then the corresponding MCS for that LPN is updated in the corresponding error tracking loop.

In some configurations, the above described tracking of downlink data quality may also be used in combination with other downlink or uplink transmission based methods. For example, in some implementations, the previously discussed UE location method based on uplink received power estimates may be used in addition to the data link layer error tracking In some implementation, uplink power estimates may be used as a “gating factor,” i.e., for deciding whether or not to use a given transmission point at all. For instance, those transmission points that have low uplink received power (e.g., below a threshold such as 10 dB below nominal) would not have good performance in the downlink and should thus not be used as it would reduce the capacity in the system. Therefore a downlink (coarse) location estimation method could optionally be used to find a subset of the transmission points that are used for the more accurate downlink location estimation. In one advantageous aspect, this determination can also reduce the number of ACK/NACK tracking loops that have to be updated as ACK/NACKs are received for data transmissions. The transmission points that have the power performance within this subset are used in order to find the transmission point combinations that give the highest MCS.

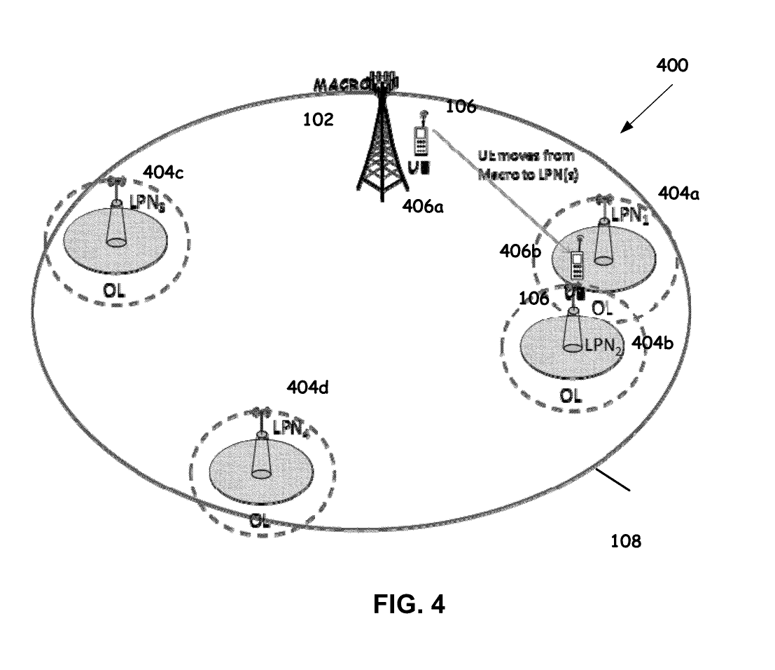

FIG. 4 illustrates a scenario in which the HetNet system 400 comprises 4 LPNs 404a, 404b, 404c and 404d that are operational inside a Macro coverage area 108 of a macro base station 102. The UE 106 shown is close to the macro base station 102, at location 406a, when downlink data transmission to the UE 106 starts (e.g., a user turns on an application that uses downlink data on the UE 106). The initial downlink location estimate may indicate that the UE 106 is closest to the Macro 102 and that the LPNs 404a, 404b, 404c and 404d are too far away. One possible way to perform the location estimation is by comparing the uplink power transmission power received at the possible downlink transmission locations: macro base station 102, and LPNs 404a, 404b, 404c and 404d.

With the UE 106 located near the macro 102, it may be determined that Macro base station 102 is the only downlink transmission node presently suitable for downlink transmissions to the UE 106. When it is determined that the macro base station 102 is the only possible downlink transmission point, then the set of MCS only contains the MCS for the macro base station 102. No downlink data transmissions from other LPNs are done for the UE 106. Then, as the UE 106 moves towards LPN1 and LPN2 (indicated by location 406b), the uplink received power for the UE 106, as measured at Macro base station 102, LPN1 404a and LPN2 404b, begins to look similar.

In some embodiments, when the uplink received power levels at macro base station 102 and LPNs 404a or 404b are within a range of one another, additional downlink transmission point possibilities may be considered. For example, one downlink transmission point combination may correspond to a particular node, e.g., the macro base station 102 (or a particular antenna asset from the macro base station 102). Another downlink transmission point combination may include joint transmissions by two or more different nodes, e.g., Macro 102 and LPN1 404a. A third possible downlink transmission point includes Macro 102 and a LPN, e.g., LPN2 404b. A fourth transmission point includes joint transmissions by the combination of Macro 102, LPN1 404a and LPN2 404b. Depending on the ACK/NACK statistics, the actual downlink transmission mode in a given transmission frame may be switched among the various possible downlink transmission point combinations. The set of all possible MCS used for downlink transmissions to the UE 106 will thus contain several MCS, with each MCS combination corresponding to one transmission point combination. The set is updated after each transmission and the reception of the corresponding ACK/NACK.

In some implementations, the transmission point combination(s) that have the highest MCS index number may be used for downlink transmissions to the UE 106. This selection may provide instantaneously the best bits per Hertz performance. However, due to the time varying nature of the channels and mobility of the UE 106, it may be beneficial to include not just the best MCS, but a time-weighted averaging of MCS by using different transmission point combinations in proportion to their MCS indices, as further described below.

In some embodiments, all transmission point combinations that have corresponding MCS index above an optional threshold may be used by multiplexing in time the usage of the combinations for downlink data transmissions. In some implementations, transmission point combinations are effectively removed from the set by setting their corresponding MCS value below the threshold (e.g., by setting MCS to zero). The ACK/NACK statistics is used to determine relative frequency with which various possible downlink transmission points are used For example, in some implementations, the downlink transmission point combination that has the highest MCS is used most frequently, followed by the transmission point that has the second highest MCS, followed by the transmission point that has the third highest MCS, and so on. In some implementations, the MCS values may be used like this for an initial frequency of use, and the frequency of use of a given transmission point may then be adjusted periodically, according to the ACK/NACK performance as described in this document.

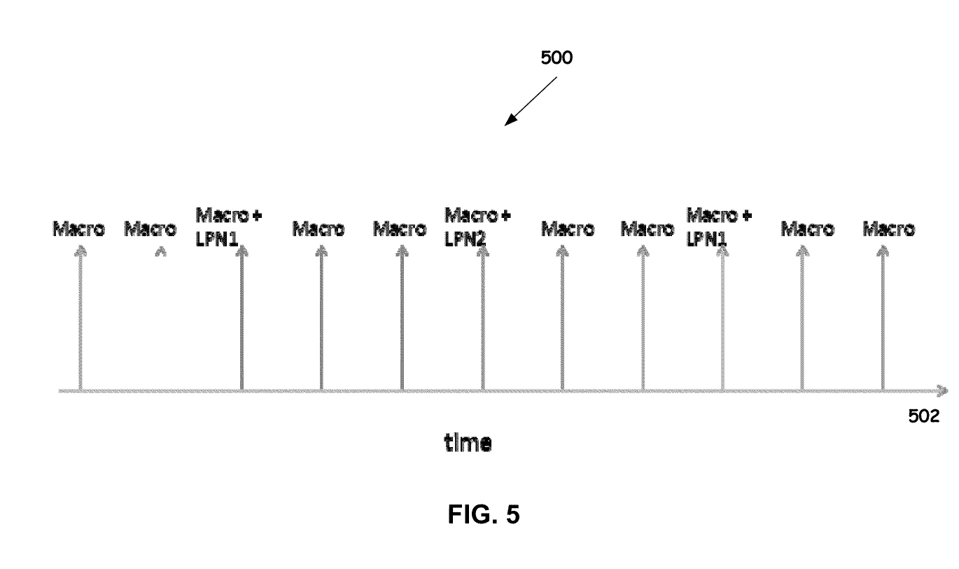

With reference to FIG. 5, an example timeline 500 of downlink transmissions to the UE 106 are plotted along the horizontal time axis 502. The timeline 500 may represent, e.g., transmission multiplexing when the UE 106 is moving from 406a to 406b (see FIG. 4), but is still mainly in the coverage of the macrocell 108. Each transmission (vertical arrow) along the timeline 500 may represent a downlink data transmission that sends to the UE 106 a next portion of data to be transmitted to the UE 106. As can be seen, Macro 102 is used more frequently to transmit downlink data to the UE 106, with fewer opportunities of joint transmissions to the transmission point combination Macro+LPN1, and no transmissions exclusively from any of the low power nodes.

In some implementations, the frequency of use of a particular downlink transmission point may be proportional to a measure of how often ACKs are successfully received for transmissions from that particular transmission point. For example, a transmission point having an x percent packet error rate, as indicated by ACK/NACK signals, may be used for downlink transmissions twice as often as another transmission point having 2x percent packet error rate.

In some implementations, the frequency of use of a transmission point may be linearly proportional to the transmission frequency. Referring back to FIG. 5, it can be seen that “Macro” transmission point combination by itself is used 4 times more often than either “Macro+LPN1” transmission point combination or “Macro+LPN2” transmission point combination. In some implementations, this may be because the packet error rate from “Macro” may be ¼th that of the other joint transmission point schemes.

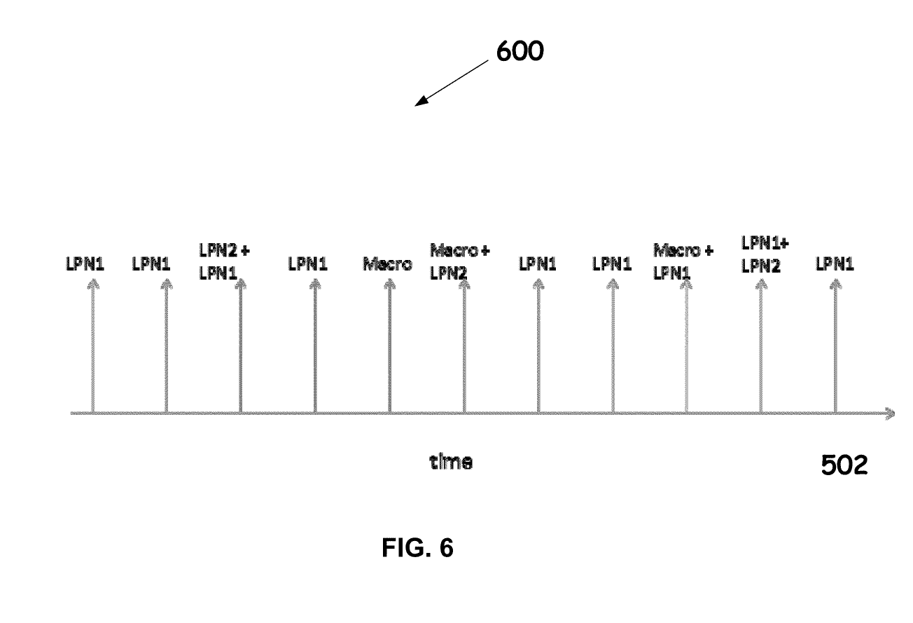

FIG. 6 discloses a timeline 600 that may represent downlink transmission multiplexing among different transmission point combinations when the UE 106 depicted in FIG. 4 moves closer to the position 406b at which it is outside of the coverage of LPN2 404b, but is in the overlap region between the Marco 102, LPN1 404a and LPN2 404b. In one example, when the UE 106 enters the LPN1 coverage area near position 406b, the MCS for the Macro is lower than the MCS for the joint transmission between Macro and LPN1. At this stage transmissions from LPN1 can be scheduled at some time instances along the timeline 600. This addition of another possible transmission point combination possibility therefore extends the MCS set by adding the corresponding MCS entry (or entries if multiple antenna combinations for LPN1 are used). If the MCS for LPN1 is better or same as the MCS for the joint transmission then the transmission from LPN1 is selected as the most frequent transmission point combination, as illustrated in FIG. 6.

In some implementations, the evaluation of the set of MCS can be done periodically (e.g., every 100 ms) or can be done after a number of transmissions (updates of the MCS set) depending on the values of the MCS in the MCS set. For instance, if there is one MCS that is much higher than the others (e.g., 64 QAM compared to QPSK), then there may not be a reason to do transmission (as frequently) from other transmission points. This can reduce the capacity in the system. If there are two or more MCS in the MCS set that have similar values, then the transmission from those transmission points can be time switched to get more accurate MCS values. However, to avoid unnecessary joint transmissions an evaluation of a number of the MCS with highest values (e.g. the four MCSs with highest values are evaluated). For instance if the MCS with highest value is a joint transmission and the MCS with the second highest value is a single transmission and the difference in MCS value is less than a certain threshold (e.g., two MCS values) then the single transmission is selected as the one that most of the transmission is scheduled from.

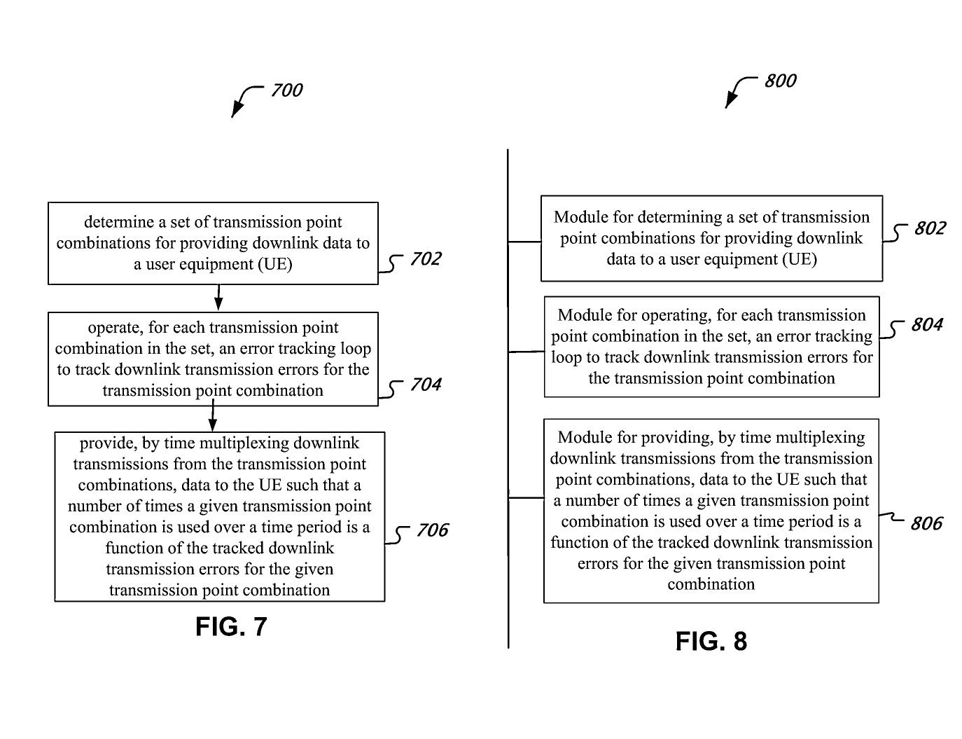

FIG. 7 is a flowchart representation of a process 700 of wireless communication for providing downlink data to a user equipment (UE) using a plurality of geographically separated transmission points in a wireless communication network. In some implementations, the process 700 may be implemented at a controller, e.g., a computer or a processor, located somewhere in a wireless network.

At 702, a set of transmission point combinations for providing downlink data is determined. In some embodiments, the set of transmission point combinations may include every possible combination including all possible downlink transmission antennas present in the system. In some embodiments, the set of transmission point combinations may include less than all combination available in the network. For example, some transmission point combinations may be excluded from the set based on operational criteria such as too little or no power is received from the UE at these transport point combinations, or because location estimation indicates that the transmission point combinations are unacceptably far away from the UE and so on.

At 704, for each transmission point combination in the set, an error tracking loop is operated to track downlink transmission errors for the transmission point combination. As previously discussed, in some embodiments, the error tracking loop may monitor the total number of downlink transmissions performed and the total number of ACKs (or NACKs) received for the downlink combinations. The error tracking loop may use a moving average, which may be windowed. For example, an error probability or error rate may be determined as a fraction or percent number (number of ACKs divided by total number of downlink transmissions or (total—# of NACKs)/total number of transmissions), that may be averaged (or lowpass filtered using another low pass filter) over past some number of (e.g., 100) transmissions or a past period (e.g., last 100 milliseconds).

At 706, data is provided to the UE by time multiplexing downlink transmissions from the transmission point combinations such that a number of times a given transmission point combination is used over a time period is a function of the tracked downlink transmission errors for the given transmission point combination. The time multiplexing is previously discussed with respect to FIGS. 5 and 6. In some implementations, the time period may be “infinite” because no repetitive pattern of transmission point combinations may be used but the transmissions may be performed randomly from various combinations in the set such that a long term average of opportunities given to a particular transmission point combination is proportional to the error free delivery from that combination. In some implementations, a transmission point combination with lower error probability is used more frequently than another transport point combination with higher error probability. In some implementations, a transmission point combination whose error probability rises above an unacceptable threshold (e.g., more than 10% packets result in NACKs), that transmission point combination may simply be dropped from the set.

The process 700 may optionally include estimating UE location and updating the set of transmission point combinations using the estimated location of the UE. For example, as previously discussed, in some embodiments, the location estimation may be based on measuring uplink received power from the UE.

As previously discussed, in some configurations, the downlink data transmissions from different transmission point combinations may use different portions of downlink data. For example, is downlink data to be transmitted to the UE could be represented as D1D2D3D4, etc., then D1 may be transmitted using a first combination, D2 may be transmitted using a second combination, D3 may be transmitted using a third transmission, etc. As previously discussed, in some embodiments, the number of times a given transmission point combination is increased linearly with increasing probability of successful transmission measured based on ACKs/NACKs received. In some implementations, the probability of successful transmission may simply be equal to (1—error probability) for a transmission point combination.

FIG. 8 is a block diagram representation of a portion of a wireless communications apparatus 800. The module 802 is for determining a set of transmission point combinations for providing downlink data. Techniques for determining the set are previously discussed in this document. The module 804 is for operating, for each transmission point combination in the set, an error tracking loop to track downlink transmission errors for the transmission point combination. The module 806 is for providing, by time multiplexing downlink transmissions from the transmission point combinations, data to the UE such that a number of times a given transmission point combination is used over a time period is a function of the tracked downlink transmission errors for the given transmission point combination. The apparatus 800 and modules 802, 804, 806 may further be configured to implement one or more techniques disclosed in this document.

In some embodiments, a wireless communication network includes a macrocell base station, at least one microcell base station and a controller. The macrocell base station includes a first transmission point and the microcell base station includes a second transmission point. The controller, which may be located at the macrocell base station or elsewhere in the network, is configured to enable transmission of wireless data from the macrocell base station and the at least one microcell base station to a user equipment (UE). The control is configured to determine a set of transmission point combinations for providing downlink data. The controller is further configured to determine, using a statistics of ACKs and NACKs received for previous downlink transmissions from the transmission point combinations, a sequence of downlink transmissions to the UE from the transmission point combinations in the set.

It will be appreciated that various techniques are disclosed for selection of downlink transmission point combinations based on downlink transmission criteria such as a probability of receiving an ACK.

It will further be appreciated that the disclosed techniques enable a controller in a HetNet to control selection of transmission points for providing downlink data to user equipment by maximizing spectral efficiency based on location of the user equipment.

The disclosed and other embodiments and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of providing downlink data to a user equipment (UE) using a plurality of geographically separated transmission points in a wireless communication network, comprising:
determining a set of transmission point combinations for providing downlink data to the UE;
operating, for each transmission point combination in the set, an error tracking loop to track downlink transmission errors for the transmission point combination; and
providing, by time multiplexing downlink transmissions from the transmission point combinations, data to the UE such that a number of times a given transmission point combination is used over a time period is a function of the tracked downlink transmission errors for the given transmission point combination.

2. The method of claim 1, wherein the operating the error tracking loop includes:
measuring an error probability using ACKs/NACKs received for downlink data transmissions.

3. The method of claim 1, further comprising:
estimating a location of the UE; and
updating, based on the estimated location, the set of transmission point combinations.

4. The method of claim 3, wherein the estimating the location of the UE includes:
measuring an uplink received power from the UE at the transmission points.

5. The method of claim 1, wherein the plurality of geographically separated transmission points include at least one macrocell base station and at least one low power node (LPN) operating to provide wireless service to a geographical region overlapping with and smaller than that serviced by the macrocell base station.

6. The method of claim 1, wherein the time multiplexed data transmissions correspond to different portions of data transmitted to the UE.

7. The method of claim 1, wherein the number of times the given transmission point combination is used increases linearly with increasing probability of successful transmission measured based on ACKs/NACKs received.

8. The method of claim 1, wherein the set is updated for every time period.

9. An apparatus for providing downlink data to a user equipment (UE) using a plurality of geographically separated transmission points in a wireless communication network, comprising:
a transmission point set determiner that determines a set of transmission point combinations for providing downlink data to the UE;
an error tracker that operates, for each transmission point combination in the set, an error tracking loop to track downlink transmission errors for the transmission point combination; and
a downlink data provider that provides, by time multiplexing downlink transmissions from the transmission point combinations, data to the UE such that a number of times a given transmission point combination is used over a time period is a function of the tracked downlink transmission errors for the given transmission point combination.

10. The apparatus of claim 9, wherein the error tracker includes:
an error probability measurer that measures an error probability using ACKs/NACKs received for downlink data transmissions.

11. The apparatus of claim 9, further comprising:
a location estimator that estimates a location of the UE; and
a transmission point set updater that updates, based on the estimated location, the set of transmission point combinations.

12. The apparatus of claim 11, wherein the location estimator includes:
an uplink power measurer that measures uplink received power from the UE at the transmission points.

13. The apparatus of claim 9, wherein the plurality of geographically separated transmission points include at least one macrocell base station and at least one low power node (LPN) operating to provide wireless service to a geographical region overlapping with and smaller than that serviced by the macrocell base station.

14. The apparatus of claim 9, wherein the time multiplexed data transmissions correspond to different portions of data transmitted to the UE.

15. The apparatus of claim 9, wherein the number of times the given transmission point combination is used increases linearly with increasing probability of successful transmission measured based on ACKs/NACKs received.

16. The apparatus of claim 9, wherein the set is updated for every time period.

17. A computer program product having computer-readable instructions stored thereupon, the instructions, when executed, causing a processor to implement a method of providing downlink data to a user equipment (UE) using a plurality of geographically separated transmission points in a wireless communication network, the method comprising:
determining a set of transmission point combinations for providing downlink data;
operating, for each transmission point combination in the set, an error tracking loop to track downlink transmission errors for the transmission point combination; and
providing, by time multiplexing downlink transmissions from the transmission point combinations, data to the UE such that a number of times a given transmission point combination is used over a time period is a function of the tracked downlink transmission errors for the given transmission point combination.

18. An apparatus for providing downlink data to a user equipment (UE) using a plurality of geographically separated transmission points in a wireless communication network, comprising:
means for determining a set of transmission point combinations for providing downlink data to the UE;
means for operating, for each transmission point combination in the set, an error tracking loop to track downlink transmission errors for the transmission point combination; and
means for providing, by time multiplexing downlink transmissions from the transmission point combinations, data to the UE such that a number of times a given transmission point combination is used over a time period is a function of the tracked downlink transmission errors for the given transmission point combination.

19. A wireless communication network, comprising:
a macrocell base station including a first transmission point;
at least one microcell base station including a second transmission point;
a controller configured to enable transmission of wireless data from the macrocell base station and the at least one microcell base station to a user equipment (UE), the controller configured to:
determine a set of transmission point combinations for providing downlink data;
determine, using a statistics of ACKs and NACKs received for previous downlink transmissions from the transmission point combinations, a sequence of downlink transmissions to the UE from the transmission point combinations in the set.

20. The wireless network of claim 19, wherein the sequence of downlink transmissions is determined such that a first transmission point combination is scheduled to transmit more often than a second transmission point combination when a higher percent of downlink transmissions from the first transmission point combinations have previously received ACK responses compared to downlink transmissions from the second transmission point combination.
